(19) United States
(12) Patent Application Publication
(10) Pub. No.: US 2026/0170716 A1
(43) Pub. Date: Jun. 18, 2026

(54) Dirty Region Detection and Reporting by Graphics Processing Unit

(71) Applicant: Google LLC, Mountain View, CA (US)

(72) Inventors: Jeykumar Sankaran, San Diego, CA (US); Jesse David Hall, Santa Clara, CA (US); Daniel Solomon, San Jose, CA (US)

(21) Appl. No.: 19/412,402

(22) Filed: Dec. 8, 2025

Related U.S. Application Data
(60) Provisional application No. 63/735,580, filed on Dec. 18, 2024.

(51) Int. Cl. G06T 11/23; G06T 1/20

(52) U.S. Cl. CPC G06T 11/23; G06T 1/20

(57) ABSTRACT

A method and system for controlling processing of pixel data for display. A first processor such as a GPU receives graphics data defining graphics content for display. The first processor translates the graphics data into pixels representing the graphics content, for use by a second processor such as a CPU to facilitate display of the graphics content. The first processor determines which of the pixels representing the graphics content are changed from pixels representing a last instance of the graphics content. Further, based on the determination of which pixels are changed from the pixels representing the last instance of the graphics content, the first processor provides to the second processor an indication of the determined pixels, which may enable the second processor to limit processing by a display engine of the pixels representing the graphics content.

### REFERENCE TO RELATED APPLICATION

This application claims priority to U.S. Provisional Patent Application No. 63/735,580, filed Dec. 18, 2024, the entirety of which is hereby incorporated by reference.

### BACKGROUND

In a typical computing device that is configured to output video content on an integrated or external display, each of one or more applications running on the device may provide to a graphics processing unit (GPU) of the device sequential blocks of graphics data each defining a respective canvas (or surface or window) of visual content to be displayed within a respective video frame. On receipt of each such request from an application, the GPU may process the request, translating the provided block of graphics data into a corresponding set of pixel-level data (pixel data) suitable for use by a display driver (e.g., a CPU-executed display manager) to cause a hardware display engine to present the graphics on the display. Further, if the display driver receives multiple sets of such pixel data corresponding with multiple canvases for a given video frame, the display driver may compose the canvases into the full video frame for presentation.

### SUMMARY

When an application provides the GPU with sequential canvases for processing, the application may also signal to the display driver per canvas to indicate what portion or portions of display content has changed since a last provided instance of the canvas. This information may enable the display driver to efficiently process just the indicated portion(s) of the pixel data provided by the GPU. For instance, if an application provides a sequence of canvases in which the only thing that changes from canvas to canvas is content in a particular rectangular area of the canvas, the application could signal to the display driver as to a given canvas to specify that rectangular area as a “dirty region,” so that, as to the pixel data that the display driver receives from the GPU for that canvas, the display driver can efficiently read and process just the pixel data within that dirty region, to facilitate change of the display specifically as to that dirty region.

Unfortunately, however, this dirty-region data that the application provides to the display driver is generally quite coarse. For instance, the application may be able to tell the display driver that a particular “region” such as a given rectangular area has changed from a preceding instance of the canvas. However, the application may not be able to inform the display driver more specifically which pixels in that dirty region have changed. As a result, the display driver may still need to process the entire dirty region of pixels, even if just certain pixels in that dirty region have changed.

The present disclosure provides a technical advance to help further improve processing efficiency. In accordance with the disclosure, when a GPU processes an application-provided canvas of graphics data, the GPU will identify pixel-level changes from a preceding frame's canvas and will inform the display driver of those pixel-level changes, to enable the display driver to process just the changed pixels rather than more generally processing one or more full dirty regions containing the changed pixels. This process takes advantage of the GPU's processing capability and focus on pixel-level data. Further, by enabling the display driver to limit its processing to just the pixel-level changes, the process may ultimately conserve processing power and battery energy if applicable.

Accordingly, in a first respect, disclosed is a method implemented by a first processor such as a GPU. The method includes (i) receiving by the first processor graphics data defining graphics content for display, (ii) translating by the first processor the graphics data to pixel-level data useable by a second processor such as a CPU to control display of the graphics content, (iii) determining by the first processor which pixels in the graphics content are changed from a last instance of graphics content, and (iv) based on the determining, providing by the first processor to the second processor an indication of the determined pixels, to enable the second processor to limit, to the indicated pixels, processing (e.g., by a hardware display engine) of the pixel-level data.

In another respect, disclosed is a method implemented by a first processor such as a CPU. The method includes (i) receiving by the first processor, from a second processor such as a GPU, a set of pixel-level data representing graphics content for display, (ii) receiving by the first processor, from the second processor, an indication of which pixels in the graphics content are changed from a last instance of graphics content, and (iii) based on the indication, limiting by the first processor, to the indicated pixels, processing (e.g., by a hardware display engine) of the received pixel-level data.

Further, in another respect, disclosed is a processor configured to carry out disclosed operations, such as those of the methods noted above for instance.

Yet further, disclosed is non-transitory data storage having stored program instructions executable by a processor to carry out operations such as those of the methods noted above for instance.

In addition, disclosed is a computer program comprising program instructions executable by a processor to carry out operations such as those of the methods noted above for instance.

These, as well as other aspects, advantages, and alternatives, will become apparent to those of ordinary skill in the art by reading the following detailed description, with reference where appropriate to the accompanying drawings. Further, it should be understood that this and other disclosure in this document is provided by way of example only and that numerous variations and other examples may be possible as well.

### BRIEF DESCRIPTION OF THE DRAWINGS

FIG. 1 is a simplified block diagram of an example device.

FIG. 2 is a simplified diagram depicting processing of graphics data for display.

FIG. 3 is an illustration of generating tile-based dirty-region data.

FIG. 4 is a flow chart illustrating an example method.

FIG. 5 is a flow chart illustrating another example method.

### DETAILED DESCRIPTION

This disclosure will discuss example implementations in the context of a device such as a smartphone having an integrated display and having a GPU that translates graphics data to pixel-level data and a CPU that executes a display manager and further executes logic that provides graphics data to the GPU for display. It will be understood, however, that the disclosed principles can apply in numerous other contexts as well, such as with respect to other devices or systems with integrated or external displays, and with other processing units or processing-unit operations, among other possibilities.

Further, it will be understood that any disclosed embodiment is not necessarily to be construed as preferred or advantageous over other embodiments unless stated as such. Further, it should be understood that variations from the specific arrangements and processes disclosed are possible. For instance, various disclosed entities, components, connections, operations, and other elements could be added, omitted, distributed, replicated, re-located, re-ordered, combined, or changed in other ways. In addition, it will be understood that various disclosed technical operations could be implemented at least in part by one or more processing units programmed to carry out the operations or to cause one or more other entities to carry out the operations.

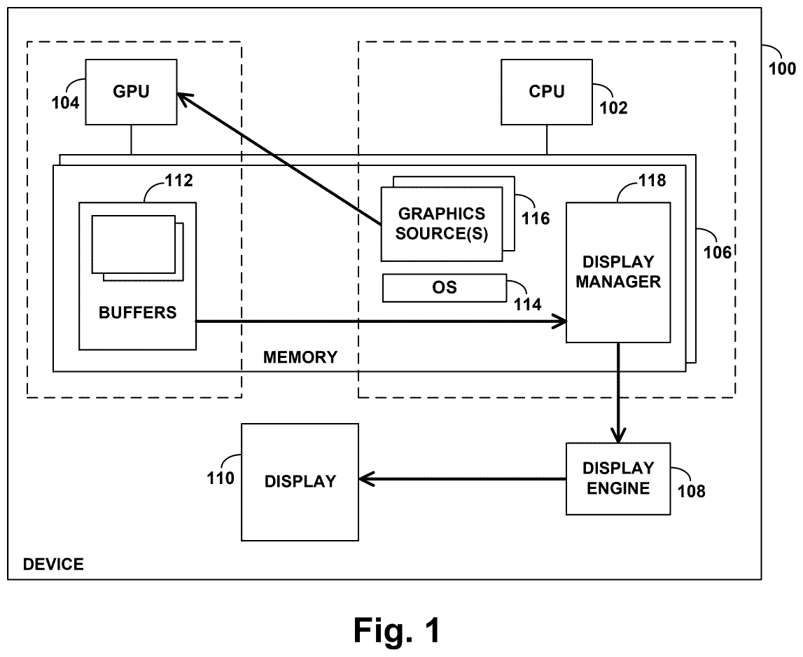

Referring to the drawings, as noted above, FIG. 1 is a simplified block diagram of an example device 100, such as a smartphone, that could be configured to carry out various disclosed features. As shown, the example device 100 includes a CPU 102, a GPU 104, memory 106, a display engine 108, and a display 110.

The CPU 102 may comprise one or more microprocessors and cache memory, among possibly other components. The GPU 104 may comprise potentially thousands of processing cores, configured to render graphics (i.e., visual content) by performing rapid mathematical calculations with highly parallel processing, to efficiently translate graphics data into pixel-level data intended for output on the display 110.

The memory 106 may comprise volatile and non-volatile data storage components, such as random access memory (RAM), electronically programmable read only memory (EPROM), electronically erasable programmable read only memory (EEPROM), and video random access memory (VRAM), among other possibilities. The memory 106 may comprise shared graphics memory that is shared by both the CPU 102 and GPU 104 and/or separate memory respectively for the CPU 102 and the GPU 104. As shown, the memory 106 may have some space reserved for use as buffers 112 to hold rendered pixel data. Further, as shown, the memory 106 may store program instructions executable by the CPU 102 and the GPU 104 to carry out various operations. For instance, the memory 106 may store instructions defining an operating system 114. Further, the memory 106 may store program instructions defining one or more graphics sources 116, such as applications and/or a user-interface framework, executable by the CPU 102 to provide graphics for processing by the GPU 104. Further, the memory 106 may store instructions defining a display manager 118 executable by the CPU 102 to manage the display engine 108.

The display engine 108 may comprise hardware interconnected with the display 110, configured to read pixel-level data provided by the GPU 104 and to correspondingly present pixels on the display 110. For instance, the display engine may be equipped to blend together the pixel-level data representing respective canvases as provided by the GPU.

The display 110 may then comprise a panel configured to present visual content at the direction of the display engine 108. Examples of display 110 technologies include, without limitation, liquid crystal display (LCD), and light emitting diode (LED) such as organic light emitting diode (OLED) or active matrix OLED (AMOLED). The display 110 may be configured to translate pixel-level data provided by the GPU 104 into signaling to trigger lighting pixels at particular rows and columns, among other possibilities.

In an example device such as this, applications or other graphics sources 116 (e.g., the CPU 102 executing program instructions defining such graphics sources 116) may issue drawing commands that request graphics content to be displayed, without actual knowledge of the structure of the display 110 that will present the graphics content and without knowledge of how the graphics content may be incorporated into a final display frame. In particular, each graphics source 116 may have a respective “canvas” (also referred to as a “surface” or “window” in some contexts), which is an abstract representation of a region in the final display, backed by one or more associated buffers. A graphics source 116 may request the GPU 104 to render content to that canvas by issuing drawing commands such as “draw a line from point A to point B”, “fill a region represented by a rectangle [x, y, w, h] with the color purple”, and/or “draw a circle with center [x, y] and radius R and fill it with the color red.” The GPU 104 may then convert those drawing commands to pixel-level data by filling a buffer with actual values, and the GPU 104 may queue the buffer to the display manager 118. Through this process, the display manager 118 may receive rendered pixel-level data as to canvases of various graphics sources 116 and may generate a composition as a video frame usable by the display engine 108 to present the graphics on the display 110. The video frame in this context may fill the entire viewport of the display.

Even in a smartphone that may have a relatively small display panel compared with, say, a desktop computer, the display manager 118 may still combine together multiple canvases for display. For instance, one or more graphics sources 116 on the smartphone may provide one or more canvases defining a background image, a status bar, a navigation bar, icons, widgets, and/or other such user-interface components, and one or more graphics sources 116 on the smartphone may provide one or more canvases representing user applications, such as a web browser, a messaging interface, and/or one or more other interfaces, among other possibilities.

With this example arrangement, the display manager 118 may compose multiple such canvases of pixel-level data together with per-canvas graphical layouts that the GPU 104 defined based on the drawing commands from the graphics sources 116. To facilitate this, when an application or other graphics source 116 provides the GPU 104 with drawing commands for a canvas to be rendered for display, the graphics source 116 may include with certain display properties for the canvas, such as an indication of size of the canvas, an indication of x, y coordinates at which to position the canvas in the video frame, and an indication of z-level of the canvas for use in layering one canvas over another (or for prioritizing which canvas may be displayed when two or more canvases would overlap) for instance. When the GPU 104 queues the associated pixel-level data to the display manager 118, the GPU 104 may convey these canvas properties to the display manager 118 as well, to enable the display manager 118 to compose a video frame for display.

When each graphics source 116 provides drawing commands to the GPU 104, the graphics source 116 may arrange for allocation of memory defining one or more buffers in which the GPU 104 can store the resulting pixel-level data. For instance, the graphics source 116 may place an application programming interface (API) call to request and cause allocation of memory space defining one or more buffers appropriate for the canvas size at issue. Once the one or more buffers are established, the graphics source 116 may then provide sequential instances of drawing commands to the GPU 104 for processing to facilitate video presentation. For instance, the graphics source 116 may repeatedly call an API providing the GPU 104 with drawing commands for the canvas. The GPU 104 may then render associated graphics data in a reserved buffer, generating associated pixel-level data for use by the display manager 118 and display engine 108.

To help improve processing efficiency when a graphics source 116 will be providing the GPU 104 with a sequence of drawing commands for a given canvas, this rendering process can make use of more than one buffer. For instance, with dual-buffering, the GPU 104 could make use of two buffers for the canvas. In particular, the GPU hardware could render into each of these buffers and queue the buffers to the display manager 118 for display. At any point in time, the buffer used by the display manager 118 is referred to as the front buffer, and the buffer that the GPU 104 is rendering to is referred to as the back buffer. Once rendering and displaying are complete, the buffers are then switched. Namely, the front buffer becomes the back buffer, and vice versa, and the process may then continue.

The process of the GPU 104 rendering a back buffer may involve the GPU 104 establishing how to visually present each of various pixels in order to represent graphics according to the drawing commands received from the graphics source 116. For instance, if the graphics source requests the GPU 104 to color the canvas with a purple background and to draw a red circle at a particular position on that background, the GPU 104 may translate those commands into pixel data in an applicable color space, defining pixels in an x, y coordinate system to represent the purple background and the positioned red circle. This translation process may involve the GPU generating a two-dimensional array of pixels representing the graphics of the canvas, and generating pixel data that represents each pixel in the applicable color space, for instance.

The GPU 104 may then write that pixel data into the back buffer, and the GPU 104 may queue that buffer to the display manager 118 as a front buffer. The display manager 118 may then cause the display engine 108 to read pixels from that front buffer and to display those pixels on the display 110. Once the display engine 108 has finished reading data from that front buffer, the memory space that defined that front buffer can then once again become a back buffer for the GPU 104 to render a next instance of drawing commands from the graphics source 116, and the process can repeat. Further, this multi-buffer construct can also be extended to any number of buffers.

Thus, in the example scenario with the red circle, if the position of the circle changes over the time from position A to position B to position C, and if there are two buffers, buffers 1 and 2, the sequence of use of the buffers may be as follows (i) position A is defined in buffer 1 (as front buffer for processing by the display manager 118), and position B is in defined in buffer 2 (as back buffer for rendering by the GPU 104), (ii) position B is defined in buffer 1 (as front buffer for processing by the display manager 118), and position C is in defined in buffer 2 (as back buffer for rendering by the GPU 104), and (iii) position C is defined in buffer 1 (as front buffer for processing by the display manager 118), etc. In this arrangement, the canvas may not change entirely; for instance, the only change here may be the position of the red circle on the purple background.

While the display engine 108 is reading pixels from a front buffer, the GPU 104 may be blocked from accessing the memory space defining that front buffer. For instance, the operating system 114 may include functionality to manage this process, to help ensure that when the display engine 108 is reading from a front buffer, no other component can access (e.g., read from or write to) the memory space defining that front buffer.

Further, when the GPU 104 queues a buffer for display, the GPU 104 may send additional data with (e.g., in) the buffer. For instance, the GPU 104 may specify a display format that may indicate how the pixels in the buffer should be read and displayed (e.g., red-green-blue (RGB) color channels, or other color formats possibly depending on pixel depth). Further, the GPU 104 may include (e.g., in the buffer) additional metadata that may tell the display manager 118 how to display the buffered content. For example, to facilitate high-dynamic-range (HDR) video display, the metadata may specify how to present the buffered data to facilitate that HDR display, e.g., by changing the color gamut for instance. The display manager 118 may thus process the data provided by the GPU 104, to facilitate having the display engine 108 render the content to the panel.

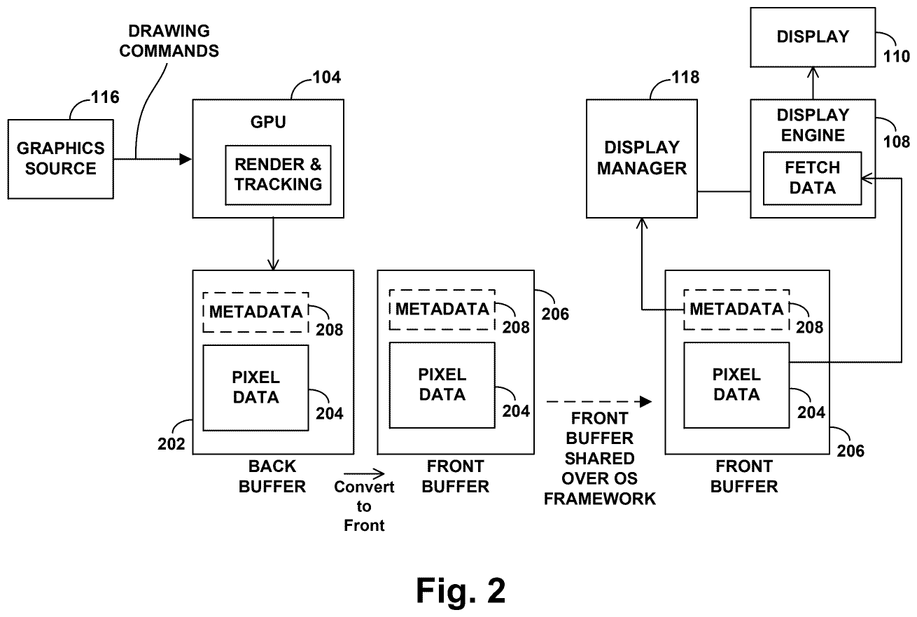

FIG. 2 illustrates accordingly how example processing of graphics data may work in an example device such as device 100 for instance. As shown in FIG. 2, a graphics source 116 may issue drawing commands to the GPU 104. The GPU 104 may then respond to those drawing commands by rendering pixel data 204 in a back buffer 202 and storing in the back buffer (or in separate auxiliary memory) a set of associated metadata 208, possibly including color space and luminance information usable by the display manager 118 to manage pixel presentation by the display engine 108. The GPU 104 may then queue that buffer to the display manager 118 as a front buffer 206.

The display manager 118 may then process that front buffer 206 (e.g., factor that buffer 206 into a composition of potentially multiple canvases), causing presentation of the pixels by the display engine 108. In particular, the display manager 118 may read the associated metadata 208 and may accordingly control the display engine 108, causing the display engine 108 to fetch the pixel data 204 from the front buffer 206, to generate a frame composition, and to accordingly present applicable pixels on the display 110.

When the CPU 102, executing the operating system 114, receives or otherwise obtains a buffer to be provided to the display manager 118 for the display manager 118 to compose into a final display frame, one relevant piece of information is any “dirty region” of that buffer. As to a canvas that is represented by the pixel data in the buffer, the dirty region is a region of pixels that is changed compared with the same positioned pixels in the immediately preceding buffer, i.e., in the immediately preceding video frame. (There may also be multiple dirty regions in a given canvas instance.) In general, this dirty-region information is optional information that the display manager 118 can make use of to help optimize the display manager's work to composing the final frame, e.g., based on the provided buffer of pixel data representing along with possibly one or more additional buffers representing other canvases to be presented concurrently. For instance, based on this dirty-region information, the display manager 118 could control the extent to which the display manager 118 processes pixel data in the front buffer and/or the extent to which the display engine 108 fetches pixel data from the front buffer, possibly limiting these operations to just the pixels within the dirty region.

In some implementations, the graphics source 116 can itself pass along to the display manager 118 information that indicates a dirty-region in a given canvas that is being processed, if the graphics source 116 has this information. In particular, the graphics source 116 can both (i) call the GPU 104 to trigger rendering of the associated back buffer and (ii) signal to the display manager 118 to provide the dirty-region information. To facilitate this, each buffer may have a unique identifier, which the graphics source 116 may accompany the buffer and which the graphics source 116 may include in its signal to the display manager 118. The display manager 118 can then efficiently use that dirty region information so as to determine what aspect of the buffer to be processed.

By way of example, consider the above example of the red circle moving from position to position on the purple background, and assume that the canvas also includes some white text in a text-box area. With this arrangement, each instance of drawing commands that the graphics source 116 provides for rendering by the GPU 104 may provide the GPU 104 with high-level graphics description instructions such as (i) fill the background in purple, (ii) draw a circle with so and so radius and position, and (iii) draw white text at so and so position. The GPU 104 may thereby figure out the final color of every pixel, for the entire canvas, specifying the color of each pixel. This process may thus convert the general directives about what to display to per-pixel directives to facilitate the displaying.

In this process, when some graphical elements on the canvas change from frame instance to frame instance, the graphics source 116 may have at best a highly coarse (fairly imprecise) view of what constitutes a dirty region. For instance, the graphics source 116 may know of the change in graphical elements at a high level but may not know what specific pixels will be impacted by that change. By way of example, if the graphics source 116 changes the white text in the text box to be different text than in an immediately preceding frame instance, the graphics source 116 may know that the text box as a whole has changed and is thus dirty (by comparison with a preceding frame instance), but the graphics source 116 may not know which associated pixels will change as a result.

If the graphics source 116 provides the display manager 118 with such a high level dirty-region information, that information will enable the display manager 118 to trigger processing of just the pixels of that dirty region. Thus, when the display manager 118 and display engine 108 read pixel data from the associated front buffer, they may conveniently limit that reading to just the pixel data for pixels in that dirty region, possibly avoiding the need to read the entire set of pixel data in the front buffer. Avoiding the need to read the entire front buffer may thereby help save energy and processing power.

Unfortunately, however, this dirty-region information may be highly coarse as noted. Therefore, the benefit of this information to the display manager 118 may be limited. For instance, if the graphics source 116 indicates that the text box containing the text has changed to contain different text, that may cause the display manager 118 to trigger reading and processing of the pixel data for pixels throughout that text-box region. But in fact, the only pixels in that region that may have changed from a last frame instance are those associated with the text itself, rather than those throughout the entire text-box region.

The present disclosure provides an advance that may help to overcome or at least partially reduce this technical issue. In accordance with the disclosure, the GPU 104 could leverage its more granular pixel-level view of the graphics information as a basis to determine more specifically which pixels change from one frame instance to the next, and the GPU 104 could convey that pixel-change information to the display manager 118 to facilitate more refined control over which pixels will be read and processed.

When a graphics source 116 provides the GPU 104 with sequential frame instances of drawing commands for a canvas, the GPU 104 may carry out this process respectively for each frame instance, by way of comparison with a preceding frame instance in the sequence. For instance, with the dual-buffer arrangement discussed above, each time the GPU 104 renders a buffer defining pixels for the canvas, the GPU 104 could compare the pixels of the canvas with the corresponding pixels (at the same coordinates) of the preceding frame instance, to identify changes. By way of example, the GPU 104 may compute cyclic redundancy check (CRC) values based on the buffer data representing pixels in each frame instance, and the GPU 104 may thus compare these CRC values as to corresponding pixels from one frame instance to the next in order to find changed pixels where the CRC values do not match.

Technically, the GPU 104 could compare every pixel of the same coordinates between the buffers (front and back) in order to identify dirtiness on a per-pixel basis. Alternatively, to conserve power (e.g., processing power and battery energy if applicable), the GPU 104 could compare pixels in groups. For instance, the GPU 104 could divide the canvas into a two-dimensional array of tiles, each containing a number of pixels, and the GPU 104 could perform its comparison between sequential frame instances on a per-tile basis, possibly computing a CRC value per tile and comparing per-tile CRC values between sequential frame instances. In this process, the pixel-to-tile mapping would be the same in each frame instance, i.e., in each buffer associated with the canvas, to facilitate the comparison. Further, the GPU 104 could define the tiles of the array to be a desired size measured in pixels (e.g., 2×2, 5×5, 10×10, or some other size, or possibly not square and/or not the same dimension as each other), with smaller sized tiles providing a more precise dirty-region analysis albeit with greater power consumption.

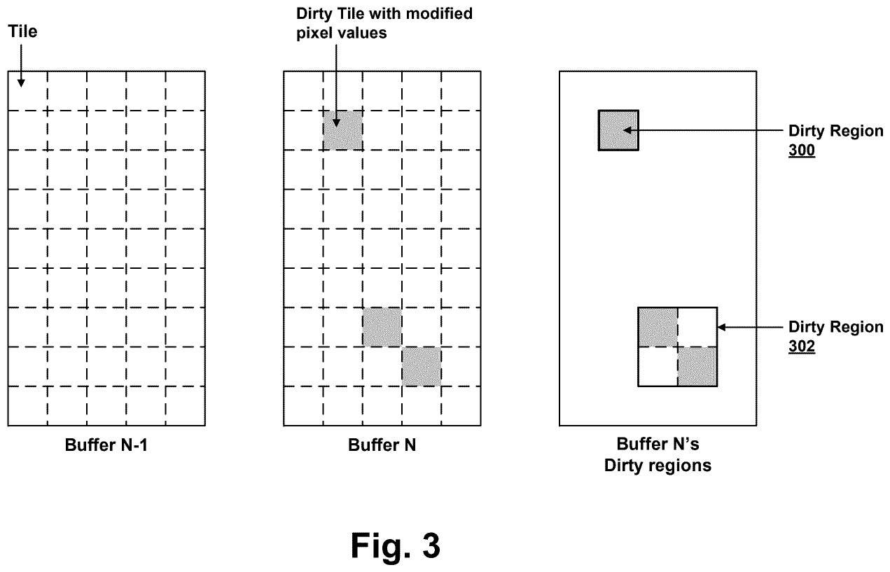

FIG. 3 illustrates an example of this tile-based dirty-region analysis. Namely, FIG. 3 illustrates a canvas in two frame instances of a sequence that the GPU 104 has rendered respectively into buffers N−1 and N. As shown, the GPU 104 may divide the pixels of each of these buffers into an array of tiles in x, y coordinates, each tile containing a particular number of pixels.

Upon rendering buffer N (or in the process of rendering buffer N), the GPU 104 may then compare each tile of buffer N with the same positioned tile of buffer N−1. For instance, for each tile, the GPU 104 may compute a respective CRC value based on the data defining the pixels in the tile, and the GPU 104 may thus compare the CRC value of each tile in buffer N with the CRC value of the corresponding tile in buffer N−1, deeming the tile to have changed if the CRC values do not match or to not have changed if the CRC values match. The GPU 104 could thereby identify each tile in buffer N that has changed compared with the corresponding tile in buffer N−1, thus defining a dirty tile in buffer N.

Note that, in some implementations, the dual-buffer processing arrangement may make it technically difficult for the GPU 104 to compare pixels of the canvas in sequential frame instances. This is because, when the GPU 104 is rendering a given buffer representing the canvas for a given frame instance, the GPU 104 may be unable to access the pixel data of the immediately preceding buffer representing the canvas for an immediately preceding frame, since that immediately preceding buffer may be restricted while being processed by the display manager 118 as noted above. The GPU 104 could overcome this further technical challenge in various ways. As one example, for instance, the GPU 104 could store a CRC value for the tiles in each buffer to facilitate comparison with a sequentially next buffer.

When the GPU 104 provides buffer N for processing by the display manager 118, the GPU 104 could then notify the display manager 118 of each dirty tile that the GPU 104 identified in buffer N. For instance, the GPU 104 could convey this dirty-tile information as part of the metadata 208, or in other associated auxiliary memory, that the GPU 104 provides for buffer N.

Alternatively, to help make the communication of this dirty-tile information more efficient, the GPU 104 could cluster or group dirty tiles into rectangular dirty regions as further shown in the figure, possibly grouping together dirty tiles that are within a threshold distance of each other, such as with one or two tiles of each other, among other possibilities. Namely, in the example shown, where the GPU 104 had identified three dirty tiles, the GPU 104 may deem one standalone dirty tile to be its own dirty region 300, and the GPU 104 may group into another dirty region 302 the other two dirty tiles that are near enough to each other. The GPU 104 may then inform the display manager of these dirty regions, such as by specifying in the associated metadata 208 the x, y coordinates (e.g., in the canvas space) and sizes of each dirty region rectangle.

Provided with this more granular dirty region information, the display manager 118 could then correspondingly control the extent of processing to facilitate presentation of the represented graphics. For instance, when the display manager 118 and display engine 108 read pixel data from the associated front buffer, they may conveniently limit that reading to just the pixel data for pixels in each specified dirty region, possibly avoiding the need to read the entire set of pixel data in the front buffer. In the arrangement of FIG. 3, for instance, the display manager 118 and display engine 108 may thus limit their reading of pixel data for buffer N to just the pixels in the two illustrated dirty regions, to facilitate updating the display of those pixels in particular.

Applying this process in the example scenario described above, with the white text in the text box, for instance, the GPU 104 may specify pixel-level dirty-region data (e.g., one or more dirty regions each made up of one or more dirty tiles) where pixels of the text changed compared with the canvas of the preceding frame instance. This information may thus enable the display manager 118 and display engine 108 to limit their pixel-level processing more specifically than to the entire text-box region, which may help to save energy and processing power.

With this process, there can be two separate tracks of dirty-region data communication. For instance, the graphics source 116 could still provide the display manager 118 with its high-level, coarse dirty-region information as noted above. Further, in parallel, the GPU 104 could generate its more granular dirty-region information, perhaps doing so automatically without the graphics source 116 instructing it to do so. As the GPU 104 renders the buffer corresponding for each frame instance, the GPU 104 may determine the pixel-level change(s) and may attach to the rendered buffer a set of metadata that specifies that pixel-level change information, so that the buffer pixel data and the metadata would flow from the GPU 104 to the display manager 118 for processing. Given this more granular dirty-region information, the display manager 118 may then use this information instead of (or possibly in addition to) the more coarse dirty-region information provided by the graphics source 116, to help control the extent of processing to facilitate graphics display.

In an alternative implementation, the graphics source 116 may query the GPU 104 to determine the more granular dirty-region information established by the GPU 104, and the graphics source 116 may itself convey this more granular dirty-region information to the display manager 118. This implementation may require some coordination of timing of per-frame-instance processing to help avoid a race condition.

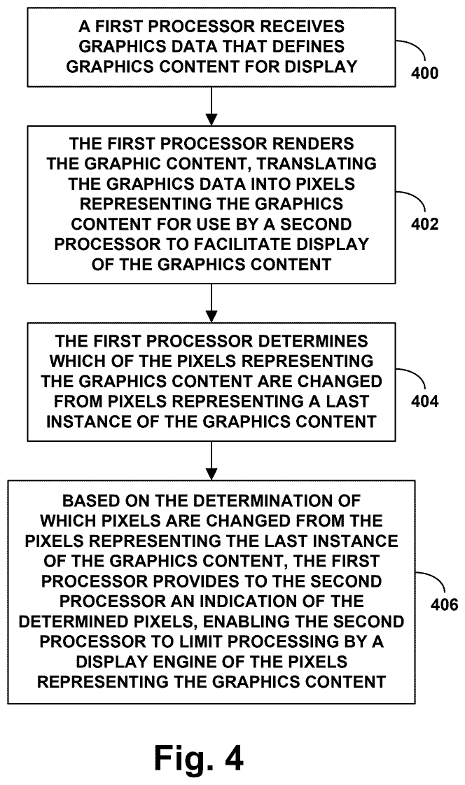

FIG. 4 is a flow chart illustrating a method that could be carried out in accordance with the present disclosure to help control processing of pixels for presentation on a display. This method could be implemented by a first processor. As shown in FIG. 4, at block 400, the first processor receives one or more drawing commands requesting display of graphics content. At block 402, the first processor renders the graphics content, translating the one or more drawing commands into pixels representing the graphics content for use by a second processor to facilitate display of the graphics content. Further, at block 404, which may occur in parallel with and/or after block 402, the first processor determines which of the pixels representing the graphics content are changed from pixels representing a last instance of the graphics content. At block 406, based on the determination of which pixels are changed from the pixels representing the last instance of the graphics content, the first processor provides to the second processor an indication of the determined pixels. This indication may thus enable the second processor to limit (e.g., to the indicated pixels) processing by a display engine of the pixels representing the graphics content.

In line with the discussion above, the first processor could be a graphics processing unit (GPU), and the second processor could be a central processing unit (CPU). Further, the CPU could execute program instructions defining a graphics source that provides the one or more drawing commands to the first processor and could further execute program instructions defining a display manager that receives from the GPU the indication of the determined pixels.

In an example implementation, the GPU and CPU could be components of a mobile computing device, such as a smartphone for instance. Further, the GPU could provide the indication of the determined pixels directly to the display manager, or the GPU could provide the indication of the determined pixels to the graphics source, and the graphics source could forward the indication of the determined pixels to the display manager, among other possibilities.

Further, as discussed above for instance, the indication of the determined pixels could be a specification of at least one dirty region representing one or more tiles, each tile of the one or more tiles containing respective pixel data changed from pixel data representing the last instance of graphics content. For instance, each dirty region could be a respective rectangular area of pixels.

Still further, the graphics content could define a frame instance of a canvas, and the act of determining which of the pixels representing the graphics content are changed from pixels representing the last instance of the graphics content could involve determining which pixels of the canvas are changed from pixels representing a preceding frame instance of the canvas.

Still further, as discussed above for instance, the act of providing to the second processor the indication of the determined pixels could involve providing the indication as metadata associated with a buffer of the pixels representing the graphics content.

Yet further, as discussed above for instance, the act of limiting, to the indicated pixels, processing by the display engine of the pixels representing the graphics content could involve limiting to the indicated pixels a process of reading from memory pixel data representing the graphics content.

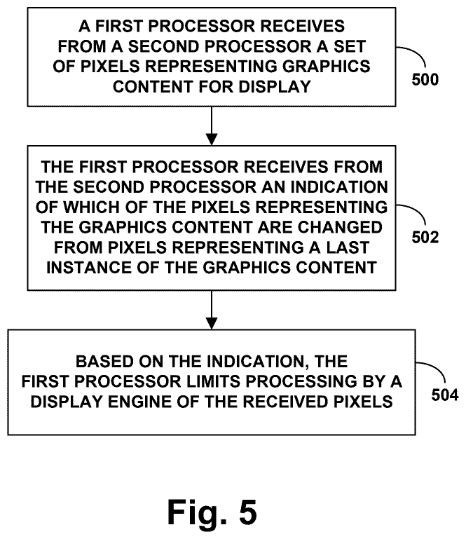

FIG. 5 is a flow chart illustrating another method that could be carried out in accordance with the present disclosure to help control processing of pixels for presentation on a display. This method could be implemented by a first processor. As shown in FIG. 5, at block 500, the first processor receives from a second processor a set of pixels representing graphics content for display. Further, at block 502, which may occur in parallel with block 500, the first processor receives from the second processor an indication of which of the pixels representing the graphics content are changed from pixels representing a last instance of the graphics content. At block 502, based on the indication, the first processor then limits (e.g., to the indicated pixels) processing by a display engine of the received pixels.

In line with the discussion above, the first processor in this method could be a CPU, and the second processor could be a GPU. Further, the CPU could execute program instructions defining a graphics source that provides to the second processor one or more drawing commands requesting rendering of the graphics content and could further execute program instructions defining a display manager that receives from the GPU the indication of which of the pixels representing the graphics content are changed from pixels representing the last instance of the graphics content.

Various features discussed above could be applied in this context as well, or vice versa.

For instance, the GPU and CPU could be components of a mobile computing device, such as a smartphone for instance.

Further, the indication of the determined pixels could be a specification of at least one dirty region representing one or more tiles, each tile of the one or more tiles containing respective pixel data changed from pixel data representing the last instance of graphics content. For instance, each dirty region could be a respective rectangular area of pixels.

Still further, the graphics content could be for a given frame instance, and the indication of which of the pixels representing the graphics content are changed from pixels representing the last instance of the graphics content could be an indication of which pixels representing the canvas for the given frame instance instance are changed from pixels representing the canvas for a preceding frame instance.

Still further, the act of receiving from the second processor the indication of which of the pixels representing the graphics content are changed from pixels representing the last instance of the graphics content could involve receiving the indication as metadata associated with a buffer of the pixels representing the graphics content.

Yet further, the act of limiting, to the indicated pixels, processing by the display engine of the pixels representing the graphics content could involve limiting to the indicated pixels a process of reading from memory pixel data representing the graphics content.

In addition, the present disclosure also contemplates non-transitory data storage (e.g., one or more non-transitory computer-readable medium components (e.g., optical, magnetic, or flash storage, RAM, ROM, EPROM, EEPROM, cache memory, and/or other computer-readable media, etc.)) holding program instructions executable by at least one processor of a device to cause the device to carry out various operations described herein.

Further, the present disclosure also contemplates a computer program comprising a set of program instructions executable by at least one processor of a device to carry out (e.g., to cause the device to carry out) various operations described herein, such as to perform the various operations of the example methods and variations discussed above. In an example implementation, the computer program could further be stored in non-transitory data storage such as that noted above, among other possibilities.

Example embodiments have been described above. Those skilled in the art will understand, however, that changes and modifications may be made to these embodiments without departing from the true scope and spirit of the invention.

What is claimed is:

1. A method comprising:
receiving, by a first processor, one or more drawing commands requesting display of graphics content;
translating, by the first processor, the one or more drawing commands into pixels representing the graphics content, for use by a second processor to facilitate display of the graphics content;
determining, by the first processor, which of the pixels representing the graphics content are changed from pixels representing a last instance of the graphics content; and
based on the determination of which pixels are changed from the pixels representing the last instance of the graphics content, providing, by the first processor to the second processor, an indication of the determined pixels, wherein the indication enables the second processor to limit processing by a display engine of the pixels representing the graphics content.

2. The method of claim 1, wherein the first processor is a graphics processing unit (GPU), and wherein the second processor is a central processing unit (CPU).

3. The method of claim 2, wherein the CPU executes program instructions defining a graphics source that provides the one or more drawing commands to the first processor and program instructions defining a display manager that receives from the GPU the indication of the determined pixels.

4. The method of claim 3, wherein the GPU provides the indication of the determined pixels to the graphics source, and the graphics source forwards the indication of the determined pixels to the display manager.

5. The method of claim 1, wherein the indication of the determined pixels comprises a specification of at least one dirty region representing one or more tiles, each tile of the one or more tiles containing respective pixel data changed from pixel data representing the last instance of graphics content.

6. The method of claim 1, wherein the graphics content defines a frame instance of a canvas, and the act of determining which of the pixels representing the graphics content are changed from pixels representing the last instance of the graphics content comprises determining which pixels of the canvas are changed from pixels representing a preceding frame instance of the canvas.

7. The method of claim 1, wherein providing to the second processor the indication of the determined pixels comprises providing the indication as metadata associated with a buffer of the pixels representing the graphics content.

8. The method of claim 1, wherein limiting, to the indicated pixels, processing by the display engine of the pixels representing the graphics content comprises limiting to the indicated pixels a process of reading, from memory, pixel data representing the graphics content.

9. A device comprising:
a first processor;
a second processor;
non-transitory data storage; and
program instructions stored in the non-transitory data storage and executable by the first processor to carry out operations including:
receiving graphics data defining graphics content for display,
translating the graphics data into pixels representing the graphics content, for use by the second processor to facilitate display of the graphics content,
determining which of the pixels representing the graphics content are changed from pixels representing a last instance of the graphics content, and
based on the determination of which pixels are changed from the pixels representing the last instance of the graphics content, providing, to the second processor, an indication of the determined pixels, wherein the indication enables the second processor to limit processing by a display engine of the pixels representing the graphics content.

10. The device of claim 9, wherein the first processor is a graphics processing unit (GPU), and wherein the second processor is a central processing unit (CPU).

11. The device of claim 10, wherein the CPU executes (i) program instructions defining a graphics source that provides to the first processor one or more drawing commands requesting rendering of the graphics content and (ii) program instructions defining a display manager that receives from the GPU the indication of the determined pixels.

12. The device of claim 11, wherein the GPU provides the indication of the determined pixels to the graphics source, and the graphics source forwards the indication of the determined pixels to the display manager.

13. The device of claim 9, wherein the indication of the determined pixels comprises a specification of at least one dirty region representing one or more tiles, each tile of the one or more tiles containing respective pixel data changed from pixel data representing the last instance of graphics content.

14. The device of claim 9, wherein the graphics content is for a given frame instance, and wherein the act of determining which of the pixels representing the graphics content are changed from pixels representing the last instance of the graphics content comprises determining which pixels representing the canvas for the given frame instance are changed from pixels representing the canvas for a preceding frame instance.

15. The device of claim 9, wherein providing to the second processor the indication of the determined pixels comprises providing the indication as metadata associated with a buffer of the pixels representing the graphics content.

16. The device of claim 9, wherein limiting, to the indicated pixels, processing by the display engine of the pixels representing the graphics content comprises limiting to the indicated pixels a process of reading from memory pixel data representing the graphics content.

17. Non-transitory computer-readable storage having stored therein program instructions executable by a first processor to carry out operations comprising:
receiving one or more drawing commands requesting display of graphics content;
translating the one or more drawing commands into pixels representing the graphics content, for use by a second processor to facilitate display of the graphics content;
determining which of the pixels representing the graphics content are changed from pixels representing a last instance of the graphics content; and
based on the determination of which pixels are changed from the pixels representing the last instance of the graphics content, providing, to the second processor, an indication of the determined pixels, wherein the indication enables the second processor to limit processing by a display engine of the pixels representing the graphics content.

18. The non-transitory computer-readable storage of claim 17, wherein the first processor is a graphics processing unit (GPU), and wherein the second processor is a central processing unit (CPU).

19. The non-transitory computer-readable storage of claim 18, wherein the CPU executes (i) program instructions defining a graphics source that provides the one or more drawing commands to the first processor and (ii) program instructions defining a display manager that receives from the GPU the indication of the determined pixels.

20. The non-transitory computer-readable storage of claim 17, wherein the indication of the determined pixels comprises a specification of at least one dirty region representing one or more tiles, each tile of the one or more tiles containing respective pixel data changed from pixel data representing the last instance of graphics content.
